(19) United States
(12) Patent Application Publication
(10) Pub. No.: US 2010/0225799 A1
(43) Pub. Date: Sep. 9, 2010

(54) IMAGE PICKUP UNIT, METHOD OF MANUFACTURING IMAGE PICKUP UNIT AND ELECTRONIC APPARATUS PROVIDED WITH IMAGE PICKUP UNIT

(75) Inventor: Noriyuki FUJIMORI, Suwa-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/714,838

(22) Filed: Mar. 1, 2010

(30) Foreign Application Priority Data
Mar. 3, 2009 (JP) 2009-049663

(51) Int. Cl. H04N 5/225; B29C 65/48

(52) U.S. Cl. 348/335; 156/60; 348/E05.024

(57) ABSTRACT

In the image pickup unit according to the present invention, of a lens group, a leg section of a lens at a tail end located closest to an image sensor in an optical axis direction is adhered to the image sensor using a UV adhesive and a light-receiving section of the image sensor is thereby sealed between the lens at the tail end and the light-receiving section via an enclosed space.

### CROSS REFERENCE TO RELATED APPLICATION

This application claims benefit of Japanese Application No. 2009-049663 filed in Japan on Mar. 3, 2009, the contents of which are incorporated by this reference.

### BACKGROUND OF THE INVENTION

1. Field of the Invention

The present invention relates to an image pickup device, an image pickup unit provided with an objective optical system provided in front of the image pickup device in an optical axis direction, a method of manufacturing the image pickup unit and an electronic apparatus provided with the image pickup unit.

2. Description of the Related Art

Conventionally, electronic apparatuses are well known such as electronic endoscopes, mobile phones with a camera, and digital cameras which are provided with an image pickup unit having an objective optical system and an image pickup apparatus provided with an image pickup device such as CCD or CMOS.

Furthermore, in recent years, a wafer level chip size package (hereinafter referred to as “WL-CSP”), type image pickup apparatus is well known as an image pickup apparatus in an image pickup unit. In a WL-CSP, cover glass wafers formed into a flat plate shape from a translucent member are pasted together at a wafer level on a sensor wafer, within a plane of which a plurality of image pickup devices are formed and the wafers are then separated through dicing or the like into respective chips for each image pickup device. A technique is known which uses this WL-CSP to perfect a plurality of image pickup apparatus packages with a cover glass for protecting a light-receiving section adhered to the light-receiving section which becomes an image pickup region in the image pickup device, and is disclosed, for example, in Japanese Patent Application Laid-Open Publication No. 2006-295481.

Furthermore, Japanese Patent Application Laid-Open Publication No. 2006-295481 discloses a configuration of an image pickup apparatus designed such that a cover glass is adhered onto the light-receiving section so that a known air gap is formed between the image pickup device and the cover glass on the light-receiving section to obtain a sufficient light condensing effect of micro lenses to improve the light condensing effect on the light-receiving section formed in the light-receiving section of the image pickup device.

### SUMMARY OF THE INVENTION

In short, an image pickup unit of the present invention is an image pickup unit provided with an image pickup device and an objective optical system provided in front of the image pickup device in an optical axis direction, wherein of the objective optical system, at least part of the objective optical system at a tail end located closest to the image pickup device in the optical axis direction is adhered to the image pickup device using a photosetting adhesive and a light-receiving section of the image pickup device is sealed between the objective optical system at the tail end and the light-receiving section via an enclosed space.

The above and other objects, features and advantages of the invention will become more clearly understood from the following description referring to the accompanying drawings.

### BRIEF DESCRIPTION OF THE DRAWINGS

FIG. 1 is a partial cross-sectional view of an image pickup unit illustrating a first embodiment;

FIG. 2 is a top view of a lens at a tail end of the image pickup unit in FIG. 1 together with an image sensor and a printed circuit board viewed from a direction II in FIG. 1;

FIG. 3 is a partial cross-sectional view illustrating a state in which the lens at the tail end is adhered to the surface of the image sensor and then a UV adhesive is hardened through irradiation of UV light;

FIG. 4 is a partial cross-sectional view of an image pickup unit illustrating a second embodiment;

FIG. 5 is a top view of the lens at the tail end of the image pickup unit in FIG. 4 together with the image sensor and the printed circuit board viewed from a direction V in FIG. 4;

FIG. 6 is a partial cross-sectional view illustrating a state in which the lens at the tail end is adhered to the printed circuit board and then a UV adhesive is hardened through irradiation of UV light; and

FIG. 7 is a partial cross-sectional view illustrating a modification example where the leg sections are removed from the lens at the tail end in FIG. 5.

### DETAILED DESCRIPTION OF THE PREFERRED EMBODIMENTS

Hereinafter, embodiments of the present invention will be explained with reference to the accompanying drawings. It should be noted, however, that the drawings are schematic ones and relationships in thickness and width among components and ratios in thickness or the like among those components are different from the actual ones, and it goes without saying that portions are included where dimensional relationships and ratios differ among the drawings.

### First Embodiment

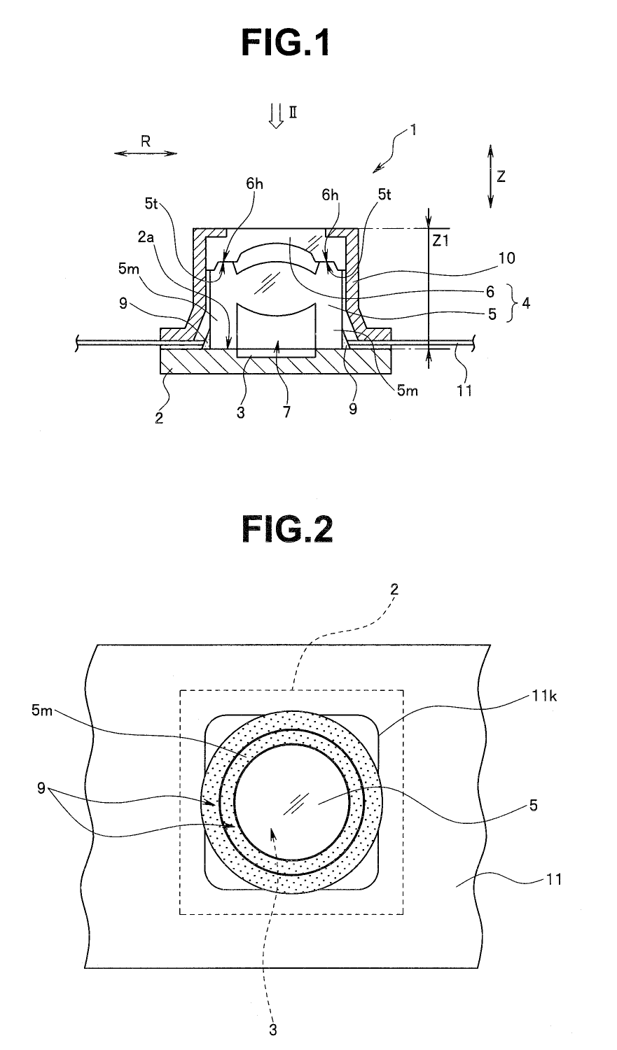

FIG. 1 is a partial cross-sectional view of an image pickup unit illustrating the present embodiment and FIG. 2 is a top view of a lens at a tail end of the image pickup unit in FIG. 1 together with an image sensor and a printed circuit board viewed from a direction II in FIG. 1.

As shown in FIG. 1, main parts of an image pickup unit 1 are made up of an image sensor 2, which is an image pickup device and a lens group 4 which is an objective optical system formed of a light transmitting member, such as a plastic lens, provided in front of the image sensor 2 in an optical axis direction Z.

A light-receiving section 3, which constitutes an image pickup region of the image sensor 2 where light from the lens group 4 is condensed is formed in substantially the central region of the image sensor 2 on a surface 2a, which is one surface of the image sensor 2 on the lens group 4 side in a plan view viewed from forward in the optical axis direction Z as shown in FIG. 2. A known micro lens (not shown) may be formed on the light-receiving section 3.

Furthermore, a signal processing-related circuit (not shown) of the image sensor 2 and a circuit for driving (not shown) of the image sensor 2 or the like are provided in a region surrounding the light-receiving section 3 in a plan view in front of the light-receiving section 3 in the optical axis direction Z on the surface 2a of the image sensor 2, that is, a region other than the light-receiving section 3.

Furthermore, as shown in FIG. 1 and FIG. 2, a terminal 8a (not shown in FIG. 1 and FIG. 2, see FIG. 4) is provided in a region other than the light-receiving section 3 of the surface 2a of the image sensor 2.

A printed circuit board 11 for transmitting/receiving various signals such as image pickup signal from the image sensor 2 to an outside circuit is electrically connected to the terminal 8a through, for example, flip chip mounting.

According to the present embodiment, the lens group 4 is made up of, for example, two lenses 5 and 6. The number of lenses making up the lens group 4 is not limited to 2, but may be 1 or 3 or more.

As shown in FIG. 1 and FIG. 2, the lens 5 of the lens group 4 is the lens placed closest to the image sensor 2 in the optical axis direction Z (hereinafter, the lens 5 will be referred to as a “tail end lens 5”).

At least part of the tail end lens 5 is adhered to the surface 2a of the image sensor 2 and the tail end lens 5 is thereby mounted on the surface 2a of the image sensor 2. The tail end lens 5 is not limited to a lens having a curved surface, but may be an optical path conversion element such as a prism.

To be more specific, the tail end lens 5 has, for example, a toric leg section 5m that extends toward the image sensor 2 side in the optical axis direction Z as shown in FIG. 2. The leg section 5m is made to contact the region other than the light-receiving section 3 of the surface 2a of the image sensor 2, subjected to photosetting adhesion, for example, hermetically adhered using, for example, a UV adhesive 9 and the tail end lens 5 is thereby mounted on the surface 2a of the image sensor 2.

This causes the space between the tail end lens 5 and the light-receiving section 3 of the surface 2a of the image sensor 2 is sealed via an enclosed space 7. In this case, the enclosed space 7 functions as a lens for condensing light to the light-receiving section 3.

Therefore, when a micro lens is formed on the light-receiving section 3, the enclosed space 7 can especially improve the light condensing effect, and therefore it is possible to form the image pickup unit 1 with higher sensitivity. Furthermore, the tail end lens 5 has the enclosed space 7 and thereby protects the light-receiving section 3.

The surface 2a of the image sensor 2 with which the leg section 5m contacts is formed inside an opening 11k of the printed circuit board 11 as shown in FIG. 2. In other words, the surface 2a of the image sensor 2 is formed in the region of the opening 11k in a plan view viewed from forward in the optical axis direction Z.

Furthermore, the leg section 5m is located along the optical axis direction Z so as to surround the light-receiving section 3 in a plan view viewed from the front in the optical axis direction Z and thereby also has the function of preventing dust or the like from entering the light-receiving section 3. The shape of the leg section 5m is not limited to the toric shape.

Furthermore, the UV adhesive 9 is applied in a toric shape along the outer edge of the surface of contact between the leg section 5m and the surface 2a of the image sensor 2 so that the outer edge is hermetically adhered to the surface 2a. The UV adhesive 9 is also intercalated between the leg section 5m and the surface 2a of the image sensor 2 in a thickness on the order of several microns.

A protrusion 5t is formed, for example, in a toric shape on the surface of the tail end lens 5 on the distal end side in the optical axis direction Z. A groove 6h, for example, in a toric shape of the lens group 4 formed in the surface on the back end side of the lens 6 (hereinafter, referred to as a “frontmost lens 6”) in the optical axis direction Z located closer to the distal end side than the tail end lens 5 in the optical axis direction Z, engages with the protrusion 5t. By this means, the position of the frontmost lens 6 in the optical axis direction Z with respect to the tail end lens 5 is defined and the positions of the lenses 5 and 6 in a diameter direction R are also defined.

As described above, the leg section 5m is made to contact the surface 2a of the image sensor 2 so that the UV adhesive 9 is intercalated between the leg section 5m and the surface 2a of the image sensor 2 in a thickness on the order of several microns, and a length Z1 of the lens group 4 in the optical axis direction Z is thereby defined in a state in which the frontmost lens 6 engages with the tail end lens 5.

A light-shielding member 10 is adhered to the circumference of the frontmost lens 6 in the diameter direction R, which prevents unnecessary light from entering the light-receiving section 3 by covering the circumference of the lens group 4 along the optical axis direction Z.

In FIG. 1, the position of the tail end lens 5 in the diameter direction R is defined only through engagement between the protrusion 5t and groove 6h and the length Z1 of the lens group 4 in the optical axis direction Z is defined only through engagement between the protrusion 5t and the groove 6h and contact between the leg section 5m and the surface 2a of the image sensor 2, and therefore the light-shielding member 10 is not adhered to the circumference of the tail end lens 5 in the diameter direction R and the printed circuit board 11.

However, if the position of the lens group 4 in the diameter direction R and optical axis direction Z can also be defined by the light-shielding member 10, the light-shielding member 10 may also be adhered to the circumference of the tail end lens 5 in the diameter direction R and printed circuit board 11.

Furthermore, the light-shielding member 10 may also be adhered to the printed circuit board 11 and the surface 2a of the image sensor 2 for the purpose of preventing dust or the like from entering the lens group 4 or securing the strength of the image pickup unit 1.

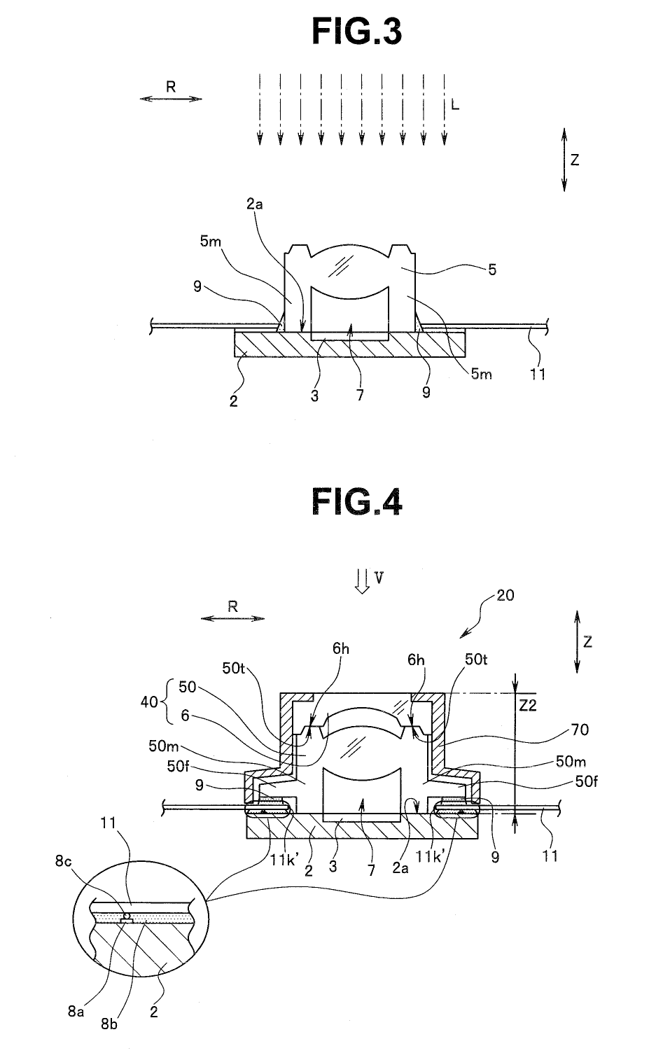

Next, operations of the present embodiment, that is, the method of manufacturing the image pickup unit 1 will be described using aforementioned FIG. 1, FIG. 2 and FIG. 3. FIG. 3 is a partial cross-sectional view illustrating a state in which the tail end lens is adhered to the surface of the image sensor and then the UV adhesive is hardened through irradiation of UV light.

First, the operator applies the UV adhesive 9 in a tonic shape while performing alignment using the position of the light-receiving section 3 as a reference so as to surround the light-receiving section 3 in a plan view viewed from forward in the optical axis direction Z as shown in FIG. 2 in the surface 2a of the image sensor 2 to which the printed circuit board 11 is electrically connected.

Likewise, the tail end lens 5 is then aligned using the position of the light-receiving section 3 of the image sensor 2 as a reference, the optical axis of the lens 5 is aligned with the center of the light-receiving section 3, that is, aligned with the position where the UV adhesive 9 has been applied, and the leg section 5m is adhered so as to contact the surface 2a via the UV adhesive 9 while adding a load of several tens of g to several hundreds of g to the tonic leg section 5m of the tail end lens 5 from forward in the optical axis direction Z.

As a result, the UV adhesive 9 is intercalated in a thickness on the order of several microns between the leg section 5m and the surface 2a and the UV adhesive 9 leaks out in a tonic shape along the outer edge of the surface of contact with the surface 2a in the circumference of the leg section 5m in the diameter direction R so that the outer edge is hermetically adhered to the surface 2a.

The leg section 5m may be adhered to the surface 2a via the UV adhesive 9 using a technique of applying the UV adhesive 9 to the contact surface of the leg section 5m first and then making the leg section 5m contact the surface 2a or making the leg section 5m contact the surface 2a, then applying the UV adhesive 9 in a tonic shape along the outer edge on the contact surface side of the leg section 5m and making the UV adhesive 9 intercalate between the leg section 5m and the surface 2a on the order of several microns using known capillarity.

Furthermore, the UV adhesive 9 is used to hermetically adhere the leg section 5m to the surface 2a of the image sensor 2 because when a thermosetting adhesive is used, if the image pickup unit 1 is placed in a high temperature environment to harden the thermosetting adhesive, the air in the enclosed space may expand and the tail end lens 5 may float forward in the optical axis direction Z, and the air may leak out of the adhesive, which may prevent the length Z1 of the lens group 4 in the optical axis direction Z from being defined.

The operator then causes the UV adhesive 9 to be irradiated with UV light L from forward in the optical axis direction Z as shown in FIG. 3. In this case, since the tail end lens 5 is formed of a light transmitting member, UV light can easily reach the UV adhesive 9, easily and reliably causing the UV adhesive 9 to harden.

As a result, an enclosed space 7 is formed between the tail end lens 5 and the light-receiving section 3 and the tail end lens 5 is mounted on the surface 2a of the image sensor 2 with the light-receiving section 3 being sealed.

After that, as shown in FIG. 1, the operator causes the groove 6h of the frontmost lens 6 with the light-shielding member 10 adhered to the circumference in the diameter direction R to engage with the protrusion 5t of the tail end lens 5 and the frontmost lens 6 thereby engages with the tail end lens 5 on the distal end side in the optical axis direction Z.

By performing such control that the protrusion 5t and the groove 6h are engaged and the UV adhesive 9 on the order of several microns is intercalated between the leg section 5m and the surface 2a, the length Z1 of the lens group 4 in the optical axis direction Z is defined. Furthermore, the engagement of the protrusion 5t with the groove 6h defines the positions of the lenses 5 and 6 in the diameter direction R.

Furthermore, frontmost lens 6 is engaged with the tail end lens 5 and the circumference of the lens group 4 in the diameter direction R is thereby covered with the light-shielding member 10 in the optical axis direction Z. The light-shielding member 10 prevents unnecessary light from entering the light-receiving section 3.

The lens group is covered with the light-shielding member 10 last because if the tail end lens 5 is engaged with the frontmost lens 6 and the lens group 4 is covered with the light-shielding member 10 before the UV adhesive 9 is irradiated with UV light L, the UV light L irradiated onto the UV adhesive 9 is shielded with the light-shielding member 10.

Thus, according to the present embodiment, in the image pickup unit 1 provided with the image sensor 2 and the lens group 4, the leg section 5m of the tail end lens 5 located closest to the image sensor 2 of the lens group 4 is hermetically adhered to the surface 2a of the image sensor via the UV adhesive 9 and the space between the tail end lens 5 and the light-receiving section 3 is sealed via the enclosed space 7 so as to protect the light-receiving section 3.

This means that the light-receiving section 3 can be protected by sealing the light-receiving section 3 using the lens 5 of the lens group 4 located in front of the image sensor 2 in the optical axis direction Z without using any cover glass as in the case of the prior art, which eliminates the necessity for the cover glass, and thereby allows the image pickup unit 1 to be formed in small size in the optical axis direction Z and the diameter direction R and at lower cost compared to the prior art.

Moreover, the use of the UV adhesive 9 as the adhesive to fix the leg section 5m to the surface 2a of the image sensor 2 allows the UV adhesive 9 to easily harden and can effectively prevent the tail end lens 5 from floating forward in the optical axis direction Z from the surface 2a of the image sensor 2.

Furthermore, since the tail end lens 5 is formed of a light transmitting member, the tail end lens 5 allows the UV light L to pass therethrough, and allows the UV adhesive 9 to be irradiated with the UV light L easily and reliably and thereby allows the UV adhesive 9 to harden, and as a result, the assembly property of the image pickup unit 1 improves.

Furthermore, the use of the image pickup unit 1 for a medical endoscope makes it possible to realize an endoscope with a smaller diameter and causing less pain for the examinee.

As described so far, it is possible to protect the light-receiving section 3 without using a separate member for protecting the light-receiving section 3 of the image sensor 2, and thereby provide a small image pickup unit 1 with improved assembly property compared to the prior art.

### Second Embodiment

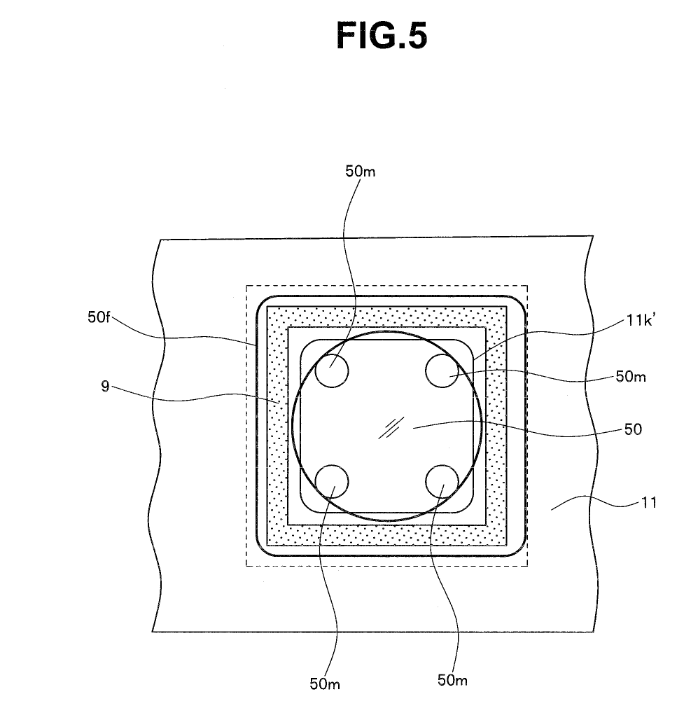

FIG. 4 is a partial cross-sectional view of an image pickup unit illustrating the present embodiment and FIG. 5 is a top view of the tail end lens of the image pickup unit in FIG. 4 together with an image sensor and a printed circuit board viewed from a direction V in FIG. 4.

The configuration of the image pickup unit of the second embodiment is different from that of the above described image pickup unit of the first embodiment shown in above FIG. 1 and FIG. 2 in that a flange section protruding from the tail end lens in the diameter direction is hermetically adhered to the printed circuit board and the light-receiving section is thereby sealed. Therefore, only this difference will be described and components similar to those of the first embodiment will be assigned the same reference numerals and descriptions thereof will be omitted.

As shown in FIG. 4, main parts of an image pickup unit 20 are made up of an image sensor 2 and a lens group 40, which is an objective optical system formed of a light transmitting member such as a plastic lens, provided in front of the image sensor 2 in the optical axis direction Z.

Furthermore, in the present embodiment, as shown in FIG. 4 and FIG. 5, a terminal 8a is also provided in a region other than a light-receiving section 3 on a surface 2a of the image sensor 2. A printed circuit board 11 for transmitting/receiving various signals such as an image pickup signal from the image sensor 2 to an outside circuit is electrically connected to the terminal 8a through, for example, flip chip mounting.

As shown in FIG. 4, the terminal 8a is sealed with sealing resin 8b and the space between the surface 2a of the image sensor 2 and the printed circuit board 11 is hermetically sealed. Furthermore, as shown in FIG. 5, an opening 11k′ of the printed circuit board 11 is formed in a rectangular shape in a plan view viewed from forward in the optical axis direction Z, and therefore the region of the terminal 8a covered with the sealing resin 8b is also formed in a rectangular shape in a plan view viewed from forward in the optical axis direction Z.

The lens group 40 is made up of, for example, two lenses 50 and 6 in the present embodiment. In the present embodiment, the number of lenses making up the lens group 40 is not limited to 2, but may be 1 or 3 or more.

As shown in FIG. 4 and FIG. 5, of the lens group 40, the lens 50 is the lens placed closest to the image sensor 2 in the optical axis direction Z (hereinafter, the lens 50 will be referred to as a “tail end lens 50”) as in the case of the first embodiment.

At least part of the tail end lens 50 is adhered to the image sensor 2, or more specifically to the printed circuit board 11 of the image sensor 2 and the tail end lens 50 is thereby mounted on the surface 2a of the image sensor 2. The tail end lens 50 is not limited to a lens having a curved surface, but may be an optical path conversion element such as a prism.

To be more specific, the tail end lens 50 has, for example, four columnar leg sections 50m that extend toward the image sensor 2 side in the optical axis direction Z as shown in FIG. 5 and also a flange section 50f extending from the tail end lens 50 in the diameter direction R in a substantially rectangular shape.

The flange section 50f is hermetically adhered to the printed circuit board 11 through photosetting adhesion, for example, via a UV adhesive 9 and the tail end lens 50 is thereby mounted on the surface 2a of the image sensor 2.

Since the UV adhesive 9 is adhered to the surface 2a of the image sensor 2, the tail end lens 50 may be mounted on the surface 2a of the image sensor 2. Furthermore, the thickness of the UV adhesive 9 in the optical axis direction Z is defined by the height of the printed circuit board 11 from the surface 2a and the height of the flange section 50f from the surface 2a.

Since the flange section 50f is hermetically adhered to the printed circuit board 11 via the UV adhesive 9, and the surface 2a of the image sensor 2 and the printed circuit board 11 are hermetically sealed together as described above, the space between the tail end lens 50 and the light-receiving section 3 of the surface 2a of the image sensor 2 is sealed via an enclosed space 7. Furthermore, the tail end lens 50 protects the light-receiving section 3 via the enclosed space 7.

Furthermore, according to the present embodiment, as shown in FIG. 5, the four leg sections 50m are formed inside the opening 11k′ of the printed circuit board 11 on the surface 2a of the image sensor 2, namely in a region inside the opening 11k′ in a plan view viewed from forward in the optical axis direction Z, and when the light-receiving section 3 is formed in a rectangular shape, the four leg sections 50m are made to contact at positions close to the corners of the light-receiving section 3 in the region other than the light-receiving section 3. According to the present embodiment, the four leg sections 50m are not adhered to the surface 2a.

Furthermore, in the present embodiment, the leg sections 50m are made up of four columnar members because the size of the opening 11k′ of the printed circuit board 11 can be reduced by enclosing the rectangular shaped light-receiving section 3 with the four leg sections rather than enclosing the four leg sections in toric shape. As a result, it is possible to secure enough space for forming the aforementioned circuit for signal processing and circuit for driving a driver in the image sensor 2. However, if this can be disregarded, the leg sections 50m may be formed in a toric shape in the present embodiment, too.

A protrusion 50t is formed, for example, in a toric shape on the surface of the tail end lens 50 on the distal end side in the optical axis direction Z. A groove 6h, for example, in a toric shape of the lens group 40 formed in the surface on the back end side of the lens 6 in the optical axis direction Z located closer to the distal end side than the tail end lens 50 in the optical axis direction Z, engages with the protrusion 50t.

This defines the position of the frontmost lens 6 in the optical axis direction Z with respect to the tail end lens 50 and also defines the positions of the lenses 50 and 6 in a diameter direction R.

According to the present embodiment, the leg sections 50m are made to directly contact the surface 2a of the image sensor 2 and the length Z2 of the lens group 40 in the optical axis direction Z when the frontmost lens 6 engages with the tail end lens 50 is defined by the height of the printed circuit board 11 from the surface 2a and the height of the flange section 50f from the surface 2a.

A light-shielding member 70 is adhered to the circumference of the frontmost lens 6 in the diameter direction R, which prevents unnecessary light from entering the light-receiving section 3 by covering the circumference of the lens group 40 along the optical axis direction Z.

In FIG. 4, the position of the tail end lens 50 in the diameter direction R is defined only through engagement between the protrusion 50t and the groove 6h and a length Z2 of the lens group 40 in the optical axis direction Z is defined only through engagement between the protrusion 50t and the groove 6h and the heights of the printed circuit board 11 and the flange section 50f from the surface 2a of the image sensor 2 and further contact of the leg sections 50m with the surface 2a, and therefore the light-shielding member 70 is not adhered to the circumference of the tail end lens 50 in the diameter direction R and the printed circuit board 11 according to the present embodiment, either.

However, if the position of the lens group 40 in the diameter direction R and the optical axis direction Z can also be defined by the light-shielding member 70, the light-shielding member 70 may also be adhered to the printed circuit board 11.

Furthermore, the light-shielding member 70 may also be adhered to the printed circuit board 11 and the surface 2a of the image sensor 2 for the purpose of preventing dust or the like from entering the lens group 40 or securing the strength of the image pickup unit 20.

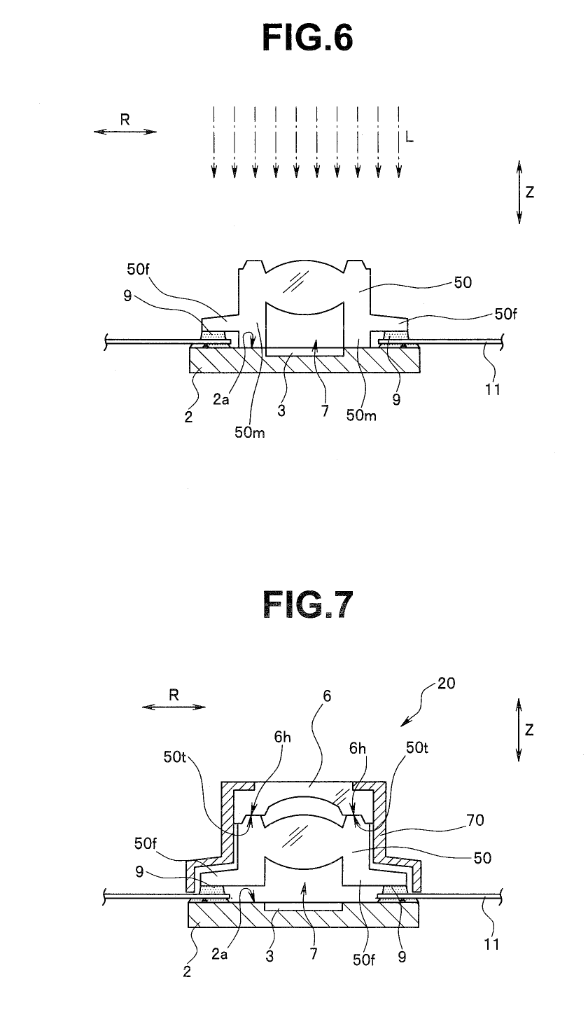

Next, operations of the present embodiment, that is, the method of manufacturing the image pickup unit 20 will be described using aforementioned FIG. 4, FIG. 5 and FIG. 6. FIG. 6 is a partial cross-sectional view illustrating a state in which the tail end lens is adhered to the printed circuit board and the UV adhesive is then hardened through irradiation of UV light.

First, the operator applies the UV adhesive 9 to the printed circuit board 11 in a substantially rectangular shape while performing alignment using the position of the light-receiving section 3 as a reference so that the light-receiving section 3 is surrounded in a plan view viewed from forward in the optical axis direction Z as shown in FIG. 5 on the surface 2a of the image sensor 2 to which the printed circuit board 11 is electrically connected.

After that, the tail end lens 50 is aligned using the position of the light-receiving section 3 of the image sensor 2 as a reference, the optical axis of the lens 50 is aligned with the center of the light-receiving section 3, the four columnar leg sections 50m of the tail end lens 50 are made to contact the surface 2a from forward in the optical axis direction Z so as to surround the light-receiving section 3 in a plan view viewed from forward in the optical axis direction Z and the flange section 50f is hermetically adhered to the UV adhesive 9 applied onto the printed circuit board 11 in a substantially rectangular shape. According to the present embodiment, the leg sections 50m are not adhered to the surface 2a.

The flange section 50f may be adhered to the printed circuit board 11 via the UV adhesive 9 by applying the UV adhesive 9 to the flange section 50f first.

The operator then causes the UV adhesive 9 to be irradiated with UV light L from forward in the optical axis direction Z as shown in FIG. 6. In this case, since the tail end lens 50 including the flange section 50f is formed of a light transmitting member, UV light L can easily reach the UV adhesive 9 and can easily and reliably cause the UV adhesive 9 to harden.

As a result, an enclosed space 7 made up of the tail end lens 50, the printed circuit board 11 and the image sensor 2 is formed between the tail end lens 50 and the light-receiving section 3 and the tail end lens 50 is mounted on the surface 2a of the image sensor 2 with the light-receiving section 3 being sealed.

After that, as shown in FIG. 4, the operator causes the groove 6h of the frontmost lens 6 with the light-shielding member 70 adhered to the circumference in the diameter direction R to engage with the protrusion 50t of the tail end lens 50 and the frontmost lens 6 is thereby engaged with the tail end lens 50 on the distal end side in the optical axis direction Z. The length Z2 of the lens group 40 from the surface 2a in the optical axis direction Z is defined through engagement between the protrusion 50t and the groove 6h and contact of the leg sections 50m with the surface 2a. Furthermore, the positions of the lenses 50 and 6 in the diameter direction R are defined through the engagement between the protrusion 50t and the groove 6h.

Furthermore, when the frontmost lens 6 engages with the tail end lens 50, the circumference of the lens group 40 in the diameter direction R is covered with the light-shielding member 70 along the optical axis direction Z. The light-shielding member 70 prevents unnecessary light from entering the light-receiving section 3.

The lens group 40 is covered with the light-shielding member 70 last because if the tail end lens 50 is engaged with the frontmost lens 6 and the lens group 40 is covered with the light-shielding member 70 before the UV adhesive 9 is irradiated with UV light L, the UV light L irradiated onto the UV adhesive 9 is shielded with the light-shielding member 70.

Thus, according to the present embodiment, in the image pickup unit 20 provided with the image sensor 2 and the lens group 40, the leg sections 50m of the tail end lens 50 located closest to the image sensor 2 of the lens group 40 are made to contact the surface 2a of the image sensor, the flange section 50f is hermetically adhered to the printed circuit board 11 which is hermetically adhered to the surface 2a via the UV adhesive 9 and the space between the tail end lens 50 and the light-receiving section 3 is sealed via the enclosed space 7 so as to protect the light-receiving section 3.

This makes it possible not only to obtain effects similar to those of the aforementioned first embodiment but also to adhere the tail end lens 50 using the flange section 50f and to thereby seat the light-receiving section 3 more reliably than in the first embodiment.

Furthermore, according to the present embodiment, since the UV adhesive 9 is not intercalated between the leg section and the surface 2a of the image sensor 2 as in the case of the aforementioned first embodiment, the leg sections 50m can be reliably made to contact the surface 2a, thus making it possible to define the height Z2 of the lens group 40 in the optical axis direction Z more accurately than in the first embodiment. That is, the assembly accuracy of the lens group 40 can be improved.

As described so far, it is possible to protect the light-receiving section 3 without using a separate member for protecting the light-receiving section 3 of the image sensor 2, and thereby provide a small image pickup unit 20 with improved assembly property compared to the prior art.

Hereinafter, a modification example will be described using FIG. 7. FIG. 7 is a partial cross-sectional view illustrating a modification example with the leg sections removed from the tail end lens in FIG. 5.

A case has been described in the aforementioned second embodiment where the leg sections 50m of the tail end lens 50 are made to contact the surface 2a of the image sensor 2.

The present invention is not limited to this and when the assembly accuracy of the lens group 40 need not be further improved, the tail end lens 50 need not have any leg section 50m as shown in FIG. 7. This makes it possible to manufacture the image pickup unit 20 at lower cost and more simply because of the absence of the leg sections 50m. The rest of the effects are the same as those of the aforementioned second embodiment.

Although a case has been described in the aforementioned first and second embodiments where the lens group 4 or lens group 40 is mounted on the image sensor 2 cut into a chip shape as an example, the present invention is not limited to this, but it is also possible to mount the lens group 4 on each image sensor 2 on a sensor wafer in which a plurality of image sensors 2 are configured within the plane using the aforementioned WL-CSP and then separate the sensor wafer into individual image sensors 2 and form a plurality of image pickup units.

Furthermore, the above described embodiments include inventions in various stages and a variety of inventions may be extracted using appropriate combinations under a plurality of configuration requirements disclosed. For example, even if some configuration requirements are deleted from all the configuration requirements described in one of the above described embodiments, when it is possible to solve the problems described in the BACKGROUND OF THE INVENTION and achieve the effects described as the effects of the invention, the configuration from which these configuration requirements are deleted may be extracted as an invention.

For example, even if some configuration requirements are deleted from all the configuration requirements described in an example, when it is possible to solve the problems described in the BACKGROUND OF THE INVENTION and achieve the effects described as the effects of the invention, the configuration from which these configuration requirements are deleted may be extracted as an invention.

Furthermore, the image pickup apparatus unit shown in the aforementioned first and second embodiments is used for an electronic apparatus. To be more specific, it goes without saying that the image pickup apparatus unit may be provided in a medical capsule endoscope or normal endoscope, or may be applicable to a mobile phone with a camera or a digital camera without being limited to endoscopes.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An image pickup unit comprising:
an image pickup device; and
an objective optical system provided in front of the image pickup device in an optical axis direction,
wherein of the objective optical system, at least part of the objective optical system at a tail end located closest to the image pickup device in the optical axis direction is adhered to the image pickup device using a photosetting adhesive and a light-receiving section of the image pickup device is sealed between the objective optical system at the tail end and the light-receiving section via an enclosed space.

2. The image pickup unit according to claim 1, wherein at least part of the objective optical system at the tail end is adhered to a circuit board electrically connected to one surface of the image pickup device on the side of the objective optical system at the tail end.

3. The image pickup unit according to claim 1, wherein at least part of the objective optical system at the tail end is a leg section that extends from the objective optical system at the tail end toward the image pickup device.

4. The image pickup unit according to claim 3, wherein the leg section is made to contact one surface of the image pickup device on the side of the objective optical system at the tail end and the length of the objective optical system in the optical axis direction is thereby defined.

5. The image pickup unit according to claim 1, wherein at least part of the objective optical system at the tail end is a flange section that extends from the objective optical system at the tail end in a diameter direction of the objective optical system

6. The image pickup unit according to claim 5, the objective optical system at the tail end further comprising a leg section that extends from the objective optical system at the tail end toward the image pickup device,
wherein the leg section is made to contact one surface of the image pickup device on the side of the objective optical system at the tail end and the length of the objective optical system in the optical axis direction is thereby defined.

7. The image pickup unit according to claim 1, wherein the objective optical system at the tail end is formed of a light transmitting member.

8. The image pickup unit according to claim 1, wherein a circumference of the objective optical system in a diameter direction is covered with a light-shielding member.

9. A method of manufacturing an image pickup unit comprising:
a step of adhering at least part of an objective optical system to a region other than a fight-receiving section of an image pickup device on one surface of the image pickup device via a photosetting adhesive and thereby forming an enclosed space between the light-receiving section and the objective optical system.

10. An electronic apparatus comprising:
an image pickup unit comprising an image pickup device and an objective optical system provided in front of the image pickup device in an optical axis direction,
wherein of the objective optical system, at least part of the objective optical system at a tail end located closest to the image pickup device in the optical axis direction is adhered to the image pickup device using a photosetting adhesive and a light-receiving section of the image pickup device is sealed between the objective optical system at the tail end and the light-receiving section via an enclosed space.

11. The electronic apparatus according to claim 10, wherein at least part of the objective optical system at the tail end is adhered to a circuit board electrically connected to one surface of the image pickup device on the side of the objective optical system at the tail end.

12. The electronic apparatus according to claim 10, wherein at least part of the objective optical system at the tail end is a leg section that extends from the objective optical system at the tail end toward the image pickup device.

13. The electronic apparatus according to claim 12, wherein the leg section is made to contact one surface of the image pickup device on the side of the objective optical system at the tail end and the length of the objective optical system in the optical axis direction is thereby defined.

14. The electronic apparatus according to claim 10, wherein at least part of the objective optical system at the tail end is a flange section that extends from the objective optical system at the tail end in a diameter direction of the objective optical system.

15. The electronic apparatus according to claim 14, the objective optical system at the tail end further comprising a leg section that extends from the objective optical system at the tail end toward the image pickup device,
wherein the leg section is made to contact one surface of the image pickup device on the side of the objective optical system at the tail end and the length of the objective optical system in the optical axis direction is thereby defined.

16. The electronic apparatus according to claim 10, wherein the objective optical system at the tail end is formed of a light transmitting member.

17. The electronic apparatus according to claim 10, wherein a circumference of the objective optical system in a diameter direction is covered with a light-shielding member.
